(19) United States
(12) Patent Application Publication
(10) Pub. No.: US 2009/0206301 A1
(43) Pub. Date: Aug. 20, 2009

(54) INORGANIC PHOSPHOR BODIES FOR LIGHT EMITTING DIODES

(75) Inventors: Marcus Antonius Verschuuren, Eindhoven (NL); Martinus Petrus Joseph Peeters, Eindhoven (NL); Jan De Graaf, Eindhoven (NL); Cornelis Gerardus Visser, Eindhoven (NL); Rene Jan Hendriks, Eindhoven (NL); Klemens Brunner, Eindhoven (NL)

Correspondence Address: Philips Intellectual Property and Standards, P.O. Box 3001, Briarcliff Manor, NY, 10510-8001, US

(73) Assignee: KONINKLIJKE PHILIPS ELECTRONICS N.V., Eindhoven (NL)

(21) Appl. No.: 12/301,151

(22) PCT Filed: May 9, 2007
(86) PCT No.: PCT/IB07/51738

§ 371 Date: Nov. 17, 2008

(30) Foreign Application Priority Data
May 29, 2006 (EP) 06114624.7

(51) Int. Cl. C09K 11/02

(52) U.S. Cl. 252/301.36

(57) ABSTRACT

An inorganic phosphor body (102) for a light emitting diode, comprising an inorganic luminescent material is provided. A bonding precursor material (103) is arranged on a surface of said inorganic phosphor body (102), and the bonding precursor material comprises an at least partly hydrolyzed organically modified silane. The attachment of the bonding precursor material to the inorganic phosphor body is separated from the bonding of the inorganic phosphor body to a light emitting diode. Thus, the attachment of the bonding precursor material to the inorganic phosphor body may be performed at conditions detrimental to the LED.

The present invention relates to inorganic phosphor bodies for light emitting diodes, phosphor converted light emitting diodes, as well as methods for the manufacture of such inorganic phosphor bodies and light emitting diodes.

LEDs (Light-Emitting Diode) are currently contemplated in several aspects of lighting, for instance general ambient lighting, signal lighting, automotive lighting, and in display device lighting, such as in backlights for LCD-displays. LEDs are currently available in different colors, from UV-diodes, via the visible range, to IR-diodes.

Problems with in particular red and amber LEDs are the strong temperature dependence of the light output and the color point, respectively. The light output as function of the junction temperature is different for red, amber, green, and blue LEDs. This effect limits the power density and increases the sensitivity to ambient temperature variations, in particular, in rear lights and blinking indicators of cars.

To partly overcome this temperature dependence, so called phosphor converted LEDs have been proposed, i.e. light emitting diodes being provided with a phosphor compound (i.e. a luminescent compound), which absorbs the light of the diode and converts it to a different color. For example, a blue diode may be provided with a red phosphor, which absorbs at least part of the blue light and consequently, emits red light.

Inorganic solid phosphor conversion bodies have been proposed for this purpose. Such conversion bodies can be manufactured with low tolerances on thickness and composition, yielding a well-defined conversion of the light.

However, such inorganic conversion bodies need to be attached to the light emitting diode by means of an optical bonding material (“optical glue”) in order to be securely fastened on the light emitting diode, and to extract sufficient light from the LED into the inorganic conversion body.

Currently this is done using silicone-gel or -rubber like materials. This silicone gel or rubber is typically a poly-di-methyl-siloxane (PDMS) based material in which part of the methyl groups can be replaced with phenyl groups in order to increase the refractive index. This material is easy to apply and handle in production (dispensing, followed by a curing step at mild temperature).

However, the family of silicones suffers from photo and thermal stability issues. Especially in combination with elevated temperatures (150° C. and above) and high light fluxes (especially blue, and UV light), degradation occurs.

Thus, there exists a need for bonding materials, which can withstand the heat and light generated by the LEDs in operation.

There also exists a need for improved methods for manufacturing phosphor converted LED with solid inorganic phosphor conversion bodies.

One object of the present invention is to at least partly overcome the above-mentioned drawbacks of the prior art and to fulfill the above-mentioned needs, and to provide light-emitting devices comprising light-emitting diodes having inorganic phosphor body arranged thereon, which light-emitting devices are easy to manufacture and where the inorganic phosphor body is bound to the light-emitting diode by means of a bonding material that is stable with regards to the light emitted by the light emitting diode and the heat dissipated by the light-emitting diode, and which provides good optical coupling between the light-emitting diode and the phosphor body.

Thus, in a first aspect, the present invention relates to an inorganic phosphor body, suitable for being arranged on a light emitting diode, comprising an inorganic luminescent material, where a bonding precursor material is arranged on a surface of the inorganic phosphor body, and the bonding precursor material comprises an at least partly hydrolyzed organically modified silane.

Such an inorganic phosphor body may, at a later stage, be used in the manufacture of a light-emitting device but may also be provided and sold as such.

One advantage of separately providing such an inorganic phosphor body for later attachment to a light emitting diode is that the attachment of the bonding precursor material to the inorganic phosphor body is separated from the bonding of the inorganic phosphor body to the light emitting diode. Thus, the attachment of the bonding precursor material to the inorganic phosphor body may be performed at conditions detrimental to the LEDs, such as by using high temperatures or certain solvents detrimental to the LEDs.

The bonding precursor material according the present invention comprises an at least partly hydrolyzed organically modified silane. When placed in contact with an LED and heated, the hydrolyzed organically modified silane condensates (cures) into a matrix of carbon and silicon atoms, where at least part of the silicon atoms are directly bound to a hydrocarbon group, thereby forming a bonding material with relatively high elasticity, due to the fact that part of the silicon atoms in the matrix are three-fold crosslinked.

It should be noted that such matrices of carbon and silicon atoms are known per se, for example from the document U.S. Pat. No. 5,991,493. However, when applied as a bonding material between LED-chips and inorganic phosphor conversion bodies, there is the unexpected effect that the material has very high photo and thermal stability, therefore making it very suitable as a bonding material between a LED and an inorganic phosphor conversion body.

Further, the material provide a bond that can handle stresses caused by thermal expansion of the LED at operating temperatures, as the silicon-matrix is, as described above, inherently flexible. In embodiments of the present invention, the bonding precursor material may further comprise an oxide of at least one element selected from the group consisting of Si, Al, Ga, Ti, Ge, P, B, Zr, Y, Sn, Pb, and Hf. Such oxides serves to increase the index of refraction index of the eventual bonding material, which in turn enhances the light coupling capability of the bond. In embodiments of the present invention, the bonding precursor material may further comprise glass particles. Such glass particles may serve to increase the index of refraction, and to act as a transparent/translucent filler material in the bonding material. Examples of at least partly hydrolyzed organically modified silanes include, but are not limited to at least partly hydrolyzed mono-organically modified trialkoxysilanes, typically of the general formula R¹—Si(OR²)(OR³)(OR⁴), where R¹ is selected from methyl, ethyl and phenyl, and where R², R³ and R⁴ independently are selected from methyl, ethyl and propyl. When hydrolyzed and condensated, such mono-organically modified trialkoxysilanes renders a photo- and thermally stable bonding material having a relatively high elasticity. Other examples of bonding precursor material includes silicon resins comprising T-silicon atoms, typically wherein at least part of the silicon atoms in the resin are directly bound to a group selected from among methyl, ethyl and phenyl.

Preferably, the bonding precursor material is a sol-gel material. In further aspects, the present invention provides methods for the manufacture of an inorganic phosphor body, a light emitting device comprising an inorganic phosphor body of the present invention attached to a light emitting diode, and methods for the manufacture of such light-emitting devices.

These and other aspects of the present invention will now be described more in detail, with reference to the appended drawings showing a currently preferred embodiment of the invention.

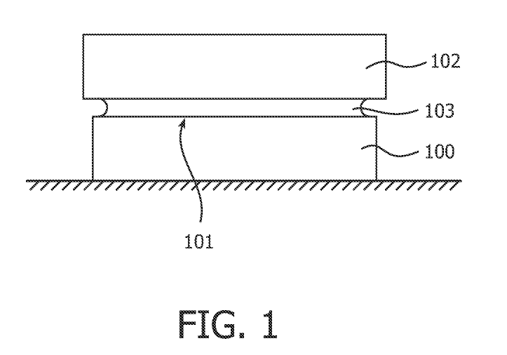

FIG. 1 schematically illustrates a phosphor converted light emitting diode of the present invention.

A phosphor-converted light emitting diode of the present invention is schematically illustrated in FIG. 1 and comprises a light emitting diode (LED) 100 having a light-emitting surface 101. On the light emitting surface is arranged an inorganic phosphor conversion body 102. The inorganic phosphor conversion body 102 is bonded to the light-emitting surface 101 of the light emitting diode 100 by means of a bonding material 103.

The bonding material 103 is at least partly transmissive or transparent, whereby upon operation of the light emitting diode, the light emitted is coupled via the bonding material 103 to the inorganic phosphor conversion body 102.

The inorganic phosphor conversion body 102 is arranged to receive at least part of the light emitted by the LED and absorbs at least part of the received light.

The inorganic phosphor conversion body 102 comprises a luminescent material that upon absorption of light emitted by the LED 100 emits light of a color different from that emitted by the LED. The luminescent material may be a fluorescent and/or phosphorescent material. As defined herein, the term “light emitting diode” (abbreviated “LED”), refers to any type of light emitting diodes known to those skilled in the art, such as, but not limited to inorganic based LEDs, polymeric based LEDs (polyLED), small organic molecule based LEDs (smOLEDs), etc. In addition, laser-emitting diodes are encompassed by the term “light emitting diodes”

For the purposes of the present invention, the LEDs emitting any light of any wavelength, from ultraviolet (UV) light, over visible light, to infrared (IR) light, are contemplated for use in the present invention. However, preferably, the LED is a UV and/or blue light emitting diode.

For the purposes of the present invention, the light emitted by the LED will be referred to as the “pump-light”, thus having a “pump-wavelength range” or “pump-color”.

In the present invention, the light-emitting surface 101 of the LED 100 is typically a polycrystalline surface, such as SiC, or a crystalline surface, such as a sapphire surface or an InGaN interface. The inorganic phosphor conversion body 102 is a solid inorganic body comprising inorganic luminescent compounds. Examples of inorganic luminescent compounds include, but are not limited to ceramic luminescent compounds.

Examples of inorganic luminescent compounds include, but are not limited to the following:

Garnet phosphors with the general formula (Lu_{1-x-y-a-b}YₓGd_{y})₃(Al_{1-z-c}Ga_{z}Si_{c})₅O_{12-c}N_{c}:CeₐPr_{b} wherein 0<x<1, 0<y<1, 0<z≦0.1, 0<a≦0.2, 0<b≦0.1, and 0<c<1, such as Lu₃Al₅O₁₂:Ce³⁺, Y₃Al₅O₁₂:Ce³⁺ and Y₃Al_{4.8}Si_{0.2}O_{11.8}N_{0.2}:Ce³⁺ which emit light in the yellow-green range; and (Sr_{1-x-y}BaₓCa_{y})_{2-z}Si₅₋ₐAlₐN₈₋₁Oₐ:Eu_{z}²⁺ 0≦a<5, 0<x≦1, 0≦y≦1, and 0<z≦1, such as Sr₂Si₅N₈:Eu²⁺, which emit light in the red range.

Other green, yellow, and red emitting phosphors, including (Sr_{1-a-b}Ca_{b}Ba_{c})SiₓN_{y}O_{z}:Euₐ²⁺ (a=0.002-0.2, b=0.0-0.25, c=0.0-0.25, x=1.5-2.5, y=1.5-2.5, z=1.5-2.5) including, for example, SrSi₂N₂O₂:Eu²⁺; (Sr₁₋ᵤ₋ᵥ₋ₓMgᵤCaᵥBaₓ)(Ga_{2-y-z}Al_{y}In_{z}S₄):Eu²⁺ including, for example, SrGa₂S₄:Eu²⁺; (Sr_{1-x-y}BaₓCa_{y})₂SiO₄:Eu²⁺ including, for example SrBaSiO₄:Eu²⁺; and (Ca₁₋ₓSrₓ)S:Eu²⁺ wherein 0<x≦1 including, for example, CaS:Eu²+ and SrS:Eu²⁺; and (Ca_{1-x-y-z}SrₓBa_{y}Mg_{z})₁₋ₙ(Al_{1-a+b}Bₐ)Si_{1-b}N_{3-b}O_{b}:REₙ, wherein 0≦x 1, 0 y≦1, 0 z≦1, 0 a≦1, 0<b≦1 and 0.002≦n≦0.2 and RE is selected from europium(II) and cerium(III), including for example CaAlSiN₃:Eu²⁺ and CaAl_{1.04}Si_{0.96}N₃:Ce³⁺; Mₓ^{v+}Si₁₂₋₍ₘ₊ₙ₎Alₘ₊ₙO₁₆₋ₙ, with x=m/v and M being a metal, preferably selected from the group comprising Li, Mg, Ca, Y, Sc, Ce, Pr, Nf, Sm, Eu, Gd, Tb, Dy, Ho, Er, Tm, Yb, Lu or mixtures thereof including, for example, Ca_{0.75}Si_{8.625}Al_{3.375}O_{1.375}N_{0.625}:Eu_{0.25}.

As used herein, the term “luminescence” refers to both fluorescence and phosphorescence, i.e. photon emission due to relaxation of excited electrons.

As used herein, “converted light” refers to the light emitted by the inorganic phosphor conversion body upon emission of the above-defined “pump-light”

As used herein, “total light” refers to the sum of the “converted light” and the “pump light” that exits the phosphor conversion body, typically comprising a component of converted light and a component of pump-light that have been transmitted through the conversion body without being absorbed.

The choice of luminescent material in the inorganic phosphor conversion body depends on the light emitting diode on which it is to be arranged, i.e. the pump-color, and on the desired color of the total light.

The desired thickness of the inorganic phosphor conversion body depends on the desired color of the total light and thus on the fraction of pump-light that is converted by the conversion body and on color of the pump-light.

In preferred embodiments of the present invention, the bonding material 103 is of a bonding material comprising a matrix including silicon and oxygen atoms, wherein at least a portion of the silicon atoms are directly bonded to hydrocarbon groups.

Such a silicon-carbon matrix based bonding material is made from a precursor material. In a preferred embodiment, the bonding precursor material comprises an at least partly hydrolyzed organically modified silane.

The at least partly hydrolyzed organically modified silane forming the bonding precursor, may be obtained by hydrolyzing a mono-organically modified silane having the general formula:

R¹—Si(OR²)(OR³)(OR⁴),

where R¹, R², R³ and R⁴ are hydrocarbon groups, and
R¹ may be selected from among aryl groups, such as phenyl, and C₁₋₈-alkyl groups, such as methyl, ethyl and propyl.

R², R², R³ and R⁴ may independently be selected from among alkyls, such as C₁₋₈-alkyls, typically methyl, ethyl and propyl.

Preferred mono-organically modified silanes to be hydrolyzed include, but are not limited to methyltrimethoxysilane, methyltriethoxysilane, ethyltrimethoxysilane, ethyltriethoxysilane, phenyltrimethoxysilane and phenyltriethoxysilane.

The above-mentioned organically modified silanes may be used alone or in any combination of two or more thereof.

In the bonding material, which will be the result after final treatment of the bonding precursor material, the refractive index will depend on the choice and concentration of the hydrocarbon group (R¹) directly bonded to silicon atoms. For example, R¹ being methyl yields a lower refractive index than RI being phenyl. Thus, the refractive index may be tailored by choosing an appropriate ratio between methyl and phenyl-modified silanes in the reaction mixture.

The above mentioned organically modified silanes are at least partly hydrolyzed to form the bonding precursor material may be obtained via a reaction path where at least part of the Si—OR², Si—OR³ and Si—OR⁴-groups of the silane are converted into Si—OH-groups by hydrolysis. Further, two Si—OH-groups may form a Si—O—Si bridge via condensation to form an oligomeric/polymeric network.

The bonding precursor material is preferably partly hydrolyzed in the sense that it contains silicon atoms to which is attached non-condensated OH-groups which may be condensated in a later stage. The condensation reaction is in general driven by heat, such that the reaction accelerates with application of heat and slows down when the reaction mixture is cooled down, such that the condensation degree may be regulated by controlled application of heat in this reaction.

The hydrolysis reaction mixture may further comprise, in addition to the above-mentioned organically modified silanes, additional silanes, such as tetra-alkoxy silanes, for example tetra-methoxysilane and/or tetra-ethoxysilane.

Such tetra-alkoxysilanes may also take part in the hydrolysis reaction, and may be included into the reaction mixture for tailoring the elasticity module of the eventual bonding material.

A network formed solely from hydrolysis and condensation of mono-organically modified silanes, such as for example phenyltrimethoxysilane (PhTMS) has a low elasticity module, due to that the phenyl group does not participate in the reaction, and does not form cross-links to adjacent silicon atoms. Thus, each silicon atom may at the most be cross-linked to three adjacent silicon atoms via oxygen bridges (Si—O—Si). For a fully hydrolyzed and condensated network, the overall formula of such a network will be (phenyl-Si—O_{1.5})ₙ.

On the other hand, a network formed solely from tetra-ethoxysilane (TEOS) has a high elasticity module, due to that each silicon atom may be cross-linked to four adjacent silicon atoms via oxygen bridges. For a fully hydrolyzed and condensated network, the overall formula of such a network will be (Si—O₂)ₙ.

By selecting a suitable ratio between mono-organically modified silane and tetra-alkoxysilane, a suitable elasticity module may thus be achieved.

Typically, the ratio (mole/mole) between mono-organically modified silane and tetra-alkoxysilane in the initial reaction mixture is in the range of from 1:0 to 1:9, typically in the range of from 9:1 to 1:9.

The bonding precursor material may further comprise oxides of at least one element selected from the group consisting of Si, Al, Ga, Ti, Ge, P, B, Zr, Y, Sn, Pb, and Hf. The oxide serves to increase the bond's index of refraction, which in turn enhances the light coupling capability of the bond. Examples include TiO₂, ZrO₂, HfO₂, Ta₂O₅, added in the form of oxide particles, typically nano scale particles, or molecular oxide precursors.

The bonding precursor material may further comprises glass particles, typically nano scale glass particles, serving to increase the bond's index of refraction, which in turn enhances the light coupling capability of the bond.

In preferred embodiments of the present invention, the bonding precursor material is a sol-gel material. In another preferred embodiments of the present invention, the bonding precursor material for forming a silicon-carbon matrix based bonding material is a silicon T-resin.

A T-resin comprises oligo- and/or polymers of partly condensated mono-organically modified silanes, where essentially all silicon atoms are so called T-silicon atoms. As used herein, the term “T-silicon atom” refers to a silicon atom, which is directly bonded to only one organic group, such as for example a methyl, ethyl or phenyl group. In addition to the directly bonded organic group, the silicon atom may further be bonded to one, two or three adjacent silicon atoms via an oxygen bridge, and to one or two OH-groups.

For the purpose of the present invention, the term “silicon atom directly bonded to an organic group”, relates to a silicon atom bonded to an organic group via a Si—C-bond. Hence, a silicon atom bonded to a methoxy group does not fall under this definition, since the methoxy group is bonded to the silicon atom via a Si—O-bond.

T-silicon atoms are grouped into T₁-silicon atoms (silicon atoms bonded to only one other silicon atom), T₂-silicon atoms (silicon atoms bonded to two other silicon atoms, and T₃-silicon atoms (silicon atoms bonded to three other silicon atoms).

In preferred T-silicon resins, the content of T₁-silicon atoms is low, typically below 10%, and the ratio between T₂- and T₃-silicon atoms is in the range of from 10:90 to 90:10, such as from 20:80 to 80:20.

The T-resin particles preferably comprise oligomers of silane networks, where the mean oligomer size is in the range of from 6 to 30 silicon atoms per oligomer, typically in the range of 8 to 18 silicon atoms.

Preferably, the end groups in the oligomers are OH-groups, so that the resin may be further condensated at a later stage.

In a T-silicon resin, the organic group directly bonded to the silicon atom may be the same for all silicon atoms in the resin or may be different for different silicon atoms. Thus, the organic groups may for example be methyl, ethyl or phenyl, or a mixture of two or more thereof. For example, the resin may contain a mixture of methyl and phenyl groups, in the ratio (mole/mole) of from about 1:9 to about 9:1, such as about 1:1.

In the bonding material, which will be the result after final treatment of the bonding precursor material, the refractive index will depend on the choice and concentration of the hydrocarbon group (R¹) directly bonded to silicon atoms in the T-resin. For example, R¹ being methyl yields a lower refractive index than R¹ being phenyl. Thus, the refractive index may be tailored by choosing a T-silicon resin having an appropriate ratio between methyl and phenyl-modified silanes, or by providing a suitable mixture of two or more different T-silicon resins.

The T-resin bonding precursor material may further comprises an oxide including at least one element selected from the group consisting of Si, Al, Ga, Ti, Ge, P, B, Zr, Y, Sn, Pb, and Hf. The oxide serves to increase the bond's index of refraction, which in turn enhances the light coupling capability of the bond. Examples include TiO₂, ZrO₂, HfO₂, Ta₂O₅, added in the form of oxide particles, typically nano scale particles, or molecular oxide precursors.

The T-resin bonding precursor material may further comprises glass particles, typically nano scale glass particles, serving to increase the bond's index of refraction, which in turn enhances the light coupling capability of the bond Methods for the manufacturing of an inorganic phosphor conversion body for a light emitting diode will now be described.

An inorganic phosphor conversion body as described above is provided. A surface of this conversion body is adapted to be bonded to the light-emitting surface of a LED (with regards to shape and size).

On this surface, a bonding precursor material is arranged. Depending on the nature of the bonding precursor material, several different application methods may be suitable for arranging the precursor material on the surface. Such methods include, but are not limited to spray-, spin- and dipcoating, ink-jet printing and dispensing. After the bonding precursor material has been arranged on the inorganic phosphor conversion body, the precursor bonding material is, if necessary, preferably treated so that the bonding precursor material is securely bonded to the surface of the inorganic phosphor conversion body.

When the bonding precursor material is a partly hydrolyzed organically modified silane, as described above, or T-silicon resin, this treatment is typically performed by drying, e.g. evaporating at least part of any liquid medium present in the precursor material.

Such an inorganic phosphor conversion body, provided with a bonding precursor material and thus being suitable for subsequent arrangement on a light emitting diode, is an especially contemplated aspect of the present invention.

Such inorganic phosphor conversion bodies (with the bonding precursor material arranged) can be pre-prepared and stored separately and may even be sold to different LED-manufacturers for implementation in their manufacturing processes for the manufacture of phosphor converted LEDs.

The inorganic phosphor bodies may also be provided with the bonding precursor material under conditions (temperature, solvent usage, pressure) that would be detrimental to the LED-die. A light emitting diode 100 is then provided, having a light-emitting surface 101 on which an inorganic phosphor conversion body 103 may be bonded.

A pre-prepared inorganic phosphor conversion body, having a surface on which a bonding precursor material is arranged as described above, is also provided.

The inorganic phosphor conversion body is then placed on top of the light-emitting surface of the LED, so that the bonding precursor material is contacted with the light-emitting surface.

A physical and optical bond between the LED and the inorganic phosphor conversion body is then obtained. This physical and optical bond may be obtained in different ways depending on the bonding precursor material used.

In the case where the bonding precursor material is a partly hydrolyzed organically modified silane or a T-silicon resin, the physical and optical bond may be obtained by curing the precursor material by applying heat, optionally while the LED and the inorganic phosphor conversion body are being pressed against each other.

Preferably, the bonding precursor material is in a gel state (such as a sol gel) when the phosphor body is arranged on the LED, since the bonding material in that case will be flexible and capable of compensating for non-flatness of the LED surface. When the bonding precursor material comprises T-resin, the material can melt or reflow upon application of a heat treatment, and can so be flexible and capable of compensating for non-flatness of the LED surface.

Alternatively, the bonding precursor material may comprise a high boiling point solvent, where the bonding precursor material is pre-dried before the bonding step. An advantage of this procedure is that it leaves the high boiling solvent as the last volatile compound to be removed by diffusion through the bonding material at the subsequent curing.

When heat is applied, formation of more Si—O—Si bonds in the precursor material is effected by condensation of at least part of any remaining Si—OH-groups. This reaction is non-reversible and leads to a curing of the bonding precursor material to the bonding material.

The water formed in the condensation reaction as well as any solvent left will evaporate during the heating step.

The temperature for this condensation is in the range of from approximately 150° C. to 450° C., depending on the precursor material.

In one example, when using a T-silicon resin as bonding precursor material, the phosphor conversion body and the T-silicon resin arranged thereon is heated to a temperature of about 130° C. and is arranged on the LED. The T-silicon resin bonding material is then cured at a temperature of about 200° C. in order to form an optical bond between the LED and the phosphor conversion body.

The resulting bonding material has been shown to exhibit good optical coupling as well as good heat and light resistance, in particular good blue and UV-resistance.

The person skilled in the art realizes that the present invention by no means is limited to the preferred embodiments described above. On the contrary, many modifications and variations are possible within the scope of the appended claims. For example, it is also possible to prepare a bonding precursor material comprising mixtures of hydrolyzed organically modified silane and glass materials, for example low-melting glass.

For example, the silane-composition may comprise particles of glass (typically in nano-size) in order to increase the refractive index of the bond.

Alternatively, a precursor material may be provided in form of an emulsion of glass particles with hydrolyzed organically modified silanes as a surface modification as an emulsifying agent. Examples of such glasses suitable for use as such filler materials include, but are not limited to low-melting chalcogenide glasses, preferably having a transition temperature Tg in the range of from 170 to 400° C. and having a high transmittance in the UV and visible range. For example, TeO₂ and SnO-based glasses, such as for example glasses having the following chemical compositions: 90% TeO₂, 10% P₂O; 75% TeO₂, 20% ZnO, 5% Na₂O; 85% TeO₂ 15% WO₃; 89% TeO₂, 11% BaO; 20% SnO, 30% P₂O₅, 50% SnF₂, may be used. All percentages in the list of glasses are in mole-percentages.

1. An inorganic phosphor body for a light emitting diode, comprising an inorganic luminescent material, and a bonding precursor material arranged on a surface of said inorganic phosphor body, said bonding precursor material comprising at least partly hydrolyzed organically modified silane.

2. An inorganic phosphor body according to claim 1, wherein said bonding precursor material further comprises an oxide of at least one element selected from the group consisting of: Si, Al, Ga, Ti, Ge, P, B, Zr, Y, Sn, Pb, and Hf

3. An inorganic phosphor body according to claim 1, wherein said bonding precursor material further comprises glass particles.

4. An inorganic phosphor body according to claim 1, wherein said bonding precursor material comprises an at least partly hydrolyzed mono-organically modified trialkoxysilane.

5. An inorganic phosphor body according to claim 4, wherein said mono-organically modified trialkoxysilane is of the formula R¹—Si(OR²)(OR³)(OR⁴), wherein R¹ is selected from the group consisting of: methyl, ethyl and phenyl, and wherein each of R², R³ and R⁴ is independently selected from the group consisting of: methyl, ethyl and propyl.

6. An inorganic phosphor body according to claim 1, wherein said bonding precursor material comprises a silicon resin comprising T-silicon atoms.

7. An inorganic phosphor body according to claim 6, wherein at least some of the silicon atoms in said silicon resin are directly bound to a group consisting of: methyl, ethyl and phenyl.

8. An inorganic phosphor body according to claim 1, wherein said bonding precursor material is a sol-gel material.

9. A method for the manufacture of an inorganic phosphor body for a light emitting diode, comprising:
(i) providing an inorganic luminescent material;
(ii) preparing a bonding precursor material comprising an at least partly hydrolyzed organically modified silane; and
(iii) arranging a layer of said bonding precursor material on a surface of said inorganic luminescent material.

10. A method according to claim 9, wherein said arranging comprises drying said bonding precursor material.

11. A light emitting device, comprising at least one light emitting diode having a light emitting surface, and an inorganic phosphor body affixed to said light emitting surface by a bonding material comprising a matrix including silicon and oxygen atom wherein at least a portion of the silicon atoms are directly bonded to hydrocarbon groups.

12. A method for the manufacture of a light emitting device, comprising:
(i) providing a light emitting diode;
(ii) providing an inorganic phosphor body comprising an inorganic luminescent material having a bonding precursor material disposed thereon, said bonding precursor material comprising at least partly hydrolyzed organically modified silane;
(iii) arranging said inorganic phosphor body on a light emitting surface of said light emitting diode, such that said bonding precursor material is in contact with said light emitting surface; and
(iv) at least partly condensating said bonding precursor material to obtain a physical and optical bond between said phosphor body and said light emitting diode.

13. A method according to claim 12, wherein said condensating is performed by heating said bonding precursor material.

14. A method according to claim 12, wherein said condensating is performed while pressing said phosphor body against said light emitting diode.
